(19) United States
(12) Patent Application Publication
(10) Pub. No.: US 2008/0051241 A1
(43) Pub. Date: Feb. 28, 2008

(54) High Performance Hybrid V-Belt

(76) Inventors: Norbert Kaps, Hannover (DE); Heiko Sattler, Hannover (DE)

Correspondence Address: WALTER OTTESEN, PO BOX 4026, GAITHERSBURG, MD, 20885-4026, US

(21) Appl. No.: 11/597,368

(22) PCT Filed: May 11, 2005
(86) PCT No.: PCT/EP05/52136

§ 371 Date: Nov. 22, 2006

(30) Foreign Application Priority Data
May 22, 2004 (DE) 10 2004 025 225.4

(51) Int. Cl. F16G 5/16

(52) U.S. Cl. 474/242

(57) ABSTRACT

A hybrid V-belt (4) has at least one tension carrier (2) and a plurality of blocks (6). The blocks function as support elements and are mounted on the tension carrier. The at least one tension carrier (2) comprises elastomeric material and is reinforced with a cord insert (12). The surfaces of the tension carrier (2) are transversely ribbed or undulated and are provided with cover layers (14, 16). To increase the fatigue strength of such hybrid V-belts, the cord insert (12) is, according to the invention, arranged directly on the lower radially inner cover (14). A direct contact between the cord ply (12) and the radially inner cover layer (14) results in the region of the zeniths (6a, . . . ) of the lower block slot flanks.

The invention relates to a hybrid V-belt (hybrid ring) according to the preamble of the patent claim.

### STATE OF THE ART

A hybrid V-belt of this kind for transmitting high power is, for example, known from EP 0 994 276 A1.

The known hybrid belt has two continuous tension carriers (load carriers) and a plurality of blocks for transmitting rotational movements between at least two belt pulleys. The plurality of blocks serve as support elements and are conical in cross section. The tension carriers are inserted into slots of the support elements. In hybrid belts having two tension carriers, these tension carriers are inserted into slots in the block with the slots on both sides extending from inclined side surfaces toward the center region of the blocks. In configurations with only one tension carrier, the tension carrier is mounted in a slot in the same manner.

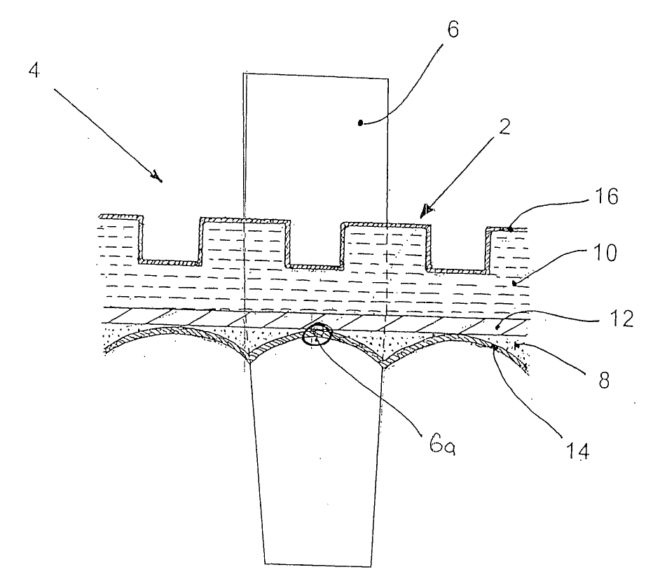

The tension carriers themselves comprise elastomeric material and are reinforced with a cord insert, that is, a cord insert is surrounded on both sides by elastomeric material. Upper and lower sides of the tension carrier are conventionally covered with a fabric (see, for example, EP 0 994 276 A1, FIG. 8).

During operation of the continuously closed hybrid V-belt of the kind, the cord supports itself against the lower radially inner rubber layer. The rubber is slowly squeezed between the support elements so that the bond between the blocks and the at least one tension carrier becomes loose. From this, disadvantages result with respect to the fatigue strength of the hybrid belt.

The configuration of a tension carrier of this kind takes place radially from inside to the outside in the following sequence: fabric, rubber plate, cord, rubber plate, fabric. With this configuration, the following manufacturing disadvantages result: during manufacture, a rubber plate must be placed twice and the cord is wound onto the first rubber plate. Because of the yieldability of the rubber, the position of the cord in radial direction is difficult to adjust since the cord is subjected to the winding tension, the viscosity and the thickness of the rubber plate. Furthermore, fluctuations of the cord layer result because of thickness tolerances of the rubber plate.

### TASK OF THE INVENTION

The task of the present invention is essentially to increase the fatigue strength of the hybrid V-belt.

### SOLUTION AND ADVANTAGES

According to the claim, the teaching of the invention is that the cord is arranged directly on the lower cover layer (that is, the radially inner cover layer) which preferably is a fabric layer.

During operation of the hybrid V-belt, only the cover layer (fabric layer) is at the contact point of the cord (tension cord) with the support element—to protect the cord—but no elastomer. That is, the cord is supported on the particular zeniths (apex points) of the radially inner slot flanks of the support elements and has no longer the possibility to press the rubber (that is, no loosening of the bond of block to tension carrier and therefore no radial sinking of the cord within the tension carrier because of a yielding of the rubber). Essentially, a longer service life is to be expected because of the avoidance of a plastic deformation. Furthermore, the degree of efficiency improves during energy transmission.

During the manufacturing process, the cord is wound directly onto the first fabric layer functioning as a cover layer. This makes possible a precise and reproducible position of the cords within the belt. The radial position of the cords in the belt is now only dependent upon the thickness of the first fabric layer onto which it is wound. During operation, the first fabric layer is subjected to only insignificant settling phenomena. The winding tension can be adjusted as desired. The most different cord materials can be used: steel cord, carbon fibers or glass fibers, aramide or polyester. When utilizing plastic cords, the possibility is provided to stretch the cord in advance so that the lengthening of the belt because of stretching of the cord is not present (that is, less lengthening).

The otherwise conventional rubber layer arranged beneath the neutral fiber is unnecessary. For this reason, the tension carrier can be configured to be thinner overall. In this way, it is possible to significantly strengthen the radial inner wings of the support elements. This adds to the transverse stiffness of the V-belt and therefore to the fatigue strength thereof.

### DRAWING

An embodiment of the invention will be explained with reference to the drawing.

### DESCRIPTION

A hybrid V-belt 4 comprises at least one tension carrier 2 and a plurality of blocks 6 which function as support elements and which are mounted on the tension carrier. In the drawing, only a single block 6 is shown by way of example.

The tension carrier 2 itself comprises elastomeric material (8, 10) and is reinforced by a cord ply 12. The upper and lower side(s) of the tension carrier 2 is (are) ribbed transversely or undulated and is (are) provided with a cover layer, for example, fabric 14 and 16, respectively. These ribbed or corrugated tension carrier surfaces are in engagement with a correspondingly structured slot surface of the blocks 6 which accommodate the tension carrier 2.

While, in conventional tension carriers, the cord ply is disposed in the middle between two rubber layers having more or less the same strength, in the tension carrier 2 of the invention, the cord ply 12 is arranged directly on the radially inner fabric 14 so that the cord 12 is supported directly on the support elements 6 during operation—only with a fabric layer 14 therebetween to protect the cord 12. There is a direct contact between the cord layer 12 and the radially inner cover layer 14 in the region of the zeniths 6a of the lower slot flanks of the blocks.

A raw rubber lower layer is omitted with respect to the cord ply 12. For this reason, the winding tension can be precisely adjusted during manufacture of the tension carrier. In addition, when using plastic filaments, the cord 12 can be stretched in advance to the extent wanted.

The gaps, which are between the cord plane and the lower crests of the tension carrier 2, are filled with rubber 8 from the raw rubber plate 10 applied above the cord plane during the vulcanization process which takes place under pressure.

### REFERENCE NUMERAL LIST

2 Tension carrier, load carrier
4 Hybrid V-belt
6 Support element, block
6a, . . . Zenith(s) [apex point(s)] of the lower block slot flank(s)
8, 10 Elastomeric material
10 Rubber layer (rubber plate)
12 Tension cord, cord, cord ply, cord filaments
14 “lower” cover layer; “lower” fabric layer; first, radial inner fabric
16 “upper” cover layer; “upper” fabric layer; second, radial outer fabric

1. (canceled)

2. A hybrid V-belt comprising:
a tension carrier;
a plurality of blocks functioning as support elements for said tension carrier;
each of said blocks having a slot formed therein wherein said tension carrier is mounted;
said tension carrier having opposite lying transversely ribbed or undulated radially inner and radially outer surfaces;
said tension carrier including elastomeric material, a cord insert for reinforcing said tension carrier and radially inner and radially outer cover layers at said radially inner and radially outer surfaces, respectively;
said slot having a lower flank in contact engagement with said tension carrier;
said lower flank being nonlinear and defining a zenith; and,
said cord insert being disposed directly on said radially inner cover layer so as to cause a direct contact between said cord insert and said radially inner cover layer at the region of said zenith of said lower flank of said slot.

3. The hybrid V-belt of claim 2, wherein each of said blocks has a conical cross section.

4. The hybrid V-belt of claim 2, wherein the nonlinear lower flank is a curved surface defining said zenith.
